(19) United States
(12) Patent Application Publication
(10) Pub. No.: US 2025/0078103 A1
(43) Pub. Date: Mar. 6, 2025

(54) SYSTEM AND METHOD FOR DETERMINING INFLUENCING FACTORS OF NET PROMOTER SCORE

(71) Applicant: DRSYA TECHNOLOGIES PRIVATE LIMITED, Bangalore (IN)

(72) Inventors: Ashish MUNGI, Bangalore (IN); Ajit RAO, Bangalore (IN); Seshagiri GUDIPUDI, Bangalore (IN)

(73) Assignee: DRSYA TECHNOLOGIES PRIVATE LIMITED, Bangalore (IN)

(21) Appl. No.: 18/820,285

(22) Filed: Aug. 30, 2024

Related U.S. Application Data
(60) Provisional application No. 63/579,970, filed on Sep. 1, 2023.

(51) Int. Cl. G06Q 30/0203; G06F 40/30

(52) U.S. Cl. CPC G06Q 30/0203; G06F 40/30

(57) ABSTRACT

A system for determining influencing factors of net promoter score (100). The system (100) comprise of plurality of modules (126) that include a data acquisition module (127) for receiving a response to a net promoter score survey from a survey respondent, a data processing module (128) for determining one or more influencing factors of net promoter score and the data processing module (128) is configured to determine a count of respondents, promoters, passives and detractors, determine a count of the responses, determine one or more key drivers in each of the responses, perform segment-wise response counts for each key driver, calculate segment-wise probabilities and an impact for each key driver, evaluate a segment-wise prioritization of key drivers, determine an overall impact and importance of each of the key drivers through a plurality of weighted averages, perform a sentiment analysis to determine a sentiment score and impact of each of the key drivers, determine the sentiment-based prioritization of key drivers, identify a set of business drivers from the key drivers and determine the business prioritization for the key drivers.

### FIELD OF THE INVENTION

Embodiments of the invention relate generally to data analysis system and method. More specifically, embodiments of the invention provide a system and method for determining influencing factors of net promoter score.

### DESCRIPTION OF THE RELATED ART

Net Promoter Score (NPS) is a widely used metric to measure customer loyalty and satisfaction and for businesses to assess customer likelihood of recommending their products or services. It is based on a simple rating question “On a scale of 0-10, how likely are you to recommend our company/product/service to a friend or colleague?”. The main rating question is frequently accompanied by an additional open-ended or “driver” question such as “Please tell us why you have given this rating?”. However, the challenges arise when trying to analyse and understand the NPS ratings.

The NPS ratings, which are continuous on a scale of 0 to 10, are further divided into three discrete nominal variables: promoters (respondents who have given a rating of 9 or 10), passives (respondents who have given a rating of 7 or 8), and detractors (respondents who have given a rating of 0 to 6). This categorization creates complexity in analysing and interpreting the NPS data accurately.

Moreover, the computation of the NPS score only considers the percentage of promoters and detractors, completely disregarding the passives category. Additionally, the reasons behind the given ratings are collected as unstructured textual data, making it challenging to identify the key drivers that influence specific NPS ratings.

The key drivers or reasons for high ratings from promoters may differ from the reasons provided by detractors with low ratings, which can further differ from the reasons provided by passives with moderate ratings. This complexity poses a challenge in accurately identifying and understanding the key drivers behind specific NPS ratings.

Therefore, due to the aforementioned drawbacks there is a need of a system and method for determining influencing factors of net promoter score.

### SUMMARY

A system and method are disclosed for determining influencing factors of net promoter score.

In a preferred embodiment, the system for determining influencing factors of net promoter score is disclosed. The system comprise of one or more hardware processors, a memory coupled to the one or more hardware processors. The memory comprises a plurality of modules in the form of programmable instructions executable by the one or more hardware processors. The plurality of modules comprise of a data acquisition module for receiving a response to a net promoter score survey from a survey respondent and a data processing module for determining one or more influencing factors of net promoter score. The data processing module is configured to determine a count of respondents, promoters, passives and detractors, determine a count of the responses, determine one or more key drivers in each of the responses, perform segment-wise response counts for each key driver, calculate segment-wise probabilities and an impact for each key driver, evaluate a segment-wise prioritization of key drivers, determine an overall impact and importance of each of the key drivers through a plurality of weighted averages, perform a sentiment analysis to determine a sentiment score and impact of each of the key drivers, determine the sentiment-based prioritization of key drivers, identify a set of business drivers from the key drivers and determine the business prioritization for the key drivers.

In a preferred embodiment, a method for determining influencing factors of net promoter score comprising of, receiving a response to a net promoter score survey from a survey respondent, determining a count of respondents, promoters, passives and detractors, determining a count of the responses, determine one or more key drivers in each of the responses, performing segment-wise response counts for each key driver, calculating one or more segment wise probabilities and an impact for each key driver, evaluating a segment-wise prioritization of key drivers, determining an overall impact and importance of each of the key drivers through a plurality of weighted averages, performing a sentiment analysis to determine a sentiment score and impact of each of the key drivers, determine the sentiment-based prioritization of key drivers, identifying a set of business drivers from the key drivers and determining the business prioritization for the key drivers.

In another embodiment, the present invention provides a non-transitory computer-readable storage medium for determining influencing factors of net promoter score. The storage medium comprising an executable code which when executed by one or more units of a system causes a processor to receive a response to a net promoter score survey from a survey respondent and determining a count of respondents, promoters, passives and detractors. The processor is further configured to determine a count of the responses and determine one or more key drivers in the response. The processor is further configured to perform a segment-wise response count for each key driver to determine the counts of the total promoter, total passive and total detractor responses containing that key driver and calculate one or more segment-wise probabilities and a segment-wise impact for each key driver. The processor is configured to evaluate a segment-wise importance and prioritization of key drivers and calculate segment-wise weights from the relative share of responses of promoters, passives and detractors. The processor is configured to determine an overall impact, importance and prioritization of each of the key drivers through a plurality of weighted averages (including simple average and weighted average) and determine the top key drivers with the highest relative impact for each segment and cumulatively across all segments. The processor is further configured to perform a sentiment analysis of the responses to determine a segment-wise sentiment score and sentiment impact of each of the key drivers and determine a sentiment-based importance and prioritization of each of the key drivers for each segment and cumulatively across all segments. The processor is further configured to determine the top N key drivers with the highest relative sentiment impact for each segment and cumulatively across all segments and identify a set of business drivers from the key drivers. The processor is further configured to determine the business impact and business prioritization of the key drivers and generate the relevant metrics, statistics, and dashboards.

In another embodiment, the present invention provides a user device for determining influencing factors of net promoter score. The user device comprise of a memory and a processor connected with the memory. The processor is configured to receive a response to a net promoter score survey from a survey respondent and determining a count of respondents, promoters, passives and detractors. The processor is further configured to determine a count of the responses and determine one or more key drivers in the response. The processor is further configured to perform a segment-wise response count for each key driver to determine the counts of the total promoter, total passive and total detractor responses containing that key driver and calculate one or more segment-wise probabilities and a segment-wise impact for each key driver. The processor is configured to evaluate a segment-wise importance and prioritization of key drivers and calculate segment-wise weights from the relative share of responses of promoters, passives and detractors. The processor is configured to determine an overall impact, importance and prioritization of each of the key drivers through a plurality of weighted averages (including simple average and weighted average) and determine the top key drivers with the highest relative impact for each segment and cumulatively across all segments. The processor is further configured to perform a sentiment analysis of the responses to determine a segment-wise sentiment score and sentiment impact of each of the key drivers and determine a sentiment-based importance and prioritization of each of the key drivers for each segment and cumulatively across all segments. The processor is further configured to determine the top N key drivers with the highest relative sentiment impact for each segment and cumulatively across all segments and identify a set of business drivers from the key drivers. The processor is further configured to determine the business impact and business prioritization of the key drivers and generate the relevant metrics, statistics, and dashboards.

### BRIEF DESCRIPTION OF THE DRAWING

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of illustrating internal and external components of an embodiment of a system in which embodiments described herein may be implemented in accordance with the present disclosure.

FIG. 2(A) and FIG. 2(B) depicts a flow diagram of a method for determining influencing factors of net promoter score in which embodiments described herein may be implemented in accordance with the present disclosure.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

The exemplary embodiments are directed to a system for determining influencing factors of net promoter score. The system comprise of one or more hardware processors, a memory coupled to the one or more hardware processors. The memory comprises a plurality of modules in the form of programmable instructions executable by the one or more hardware processors. The plurality of modules comprise of a data acquisition module for receiving a response to a net promoter score survey from a survey respondent and a data processing module for determining one or more influencing factors of net promoter score. The data processing module is configured to determine a count of respondents, promoters, passives and detractors, determine a count of the responses, determine one or more key drivers in each of the responses, perform segment-wise response counts for each key driver, calculate segment-wise probabilities and an impact for each key driver, evaluate a segment-wise prioritization of key drivers, determine an overall impact and importance of each of the key drivers through a plurality of weighted averages, perform a sentiment analysis to determine a sentiment score and impact of each of the key drivers, determine the sentiment-based prioritization of key drivers, identify a set of business drivers from the key drivers and determine the business prioritization for the key drivers.

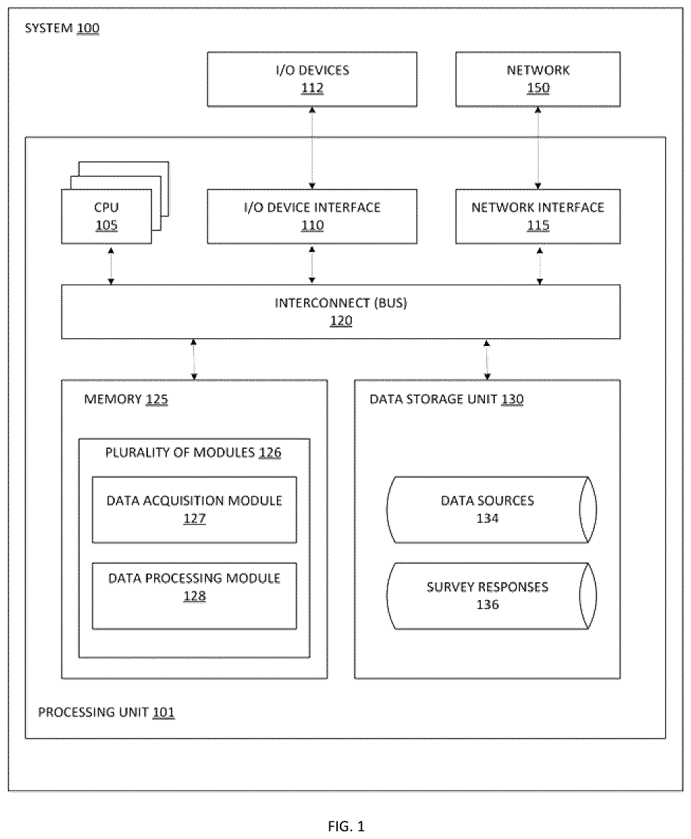

FIG. 1 depicts a block diagram of illustrating internal and external components of an embodiment of a system in which embodiments described herein may be implemented in accordance with the present disclosure. The system (100) comprises one or more processing units (101). Each processing unit (101) includes a memory (125), data storage (130), an interconnect (e.g., BUS) (120), one or more processors (e.g., CPUs) (105), an I/O device interface (110), I/O devices (112), and a network interface (115).

Each processor (105) can be communicatively coupled to the memory (125) or storage (130). Each processor (105) can retrieve and execute programming instructions stored in memory (125) or storage (130). The interconnect (120) is used to move data, such as programming instructions, between the CPU (105), I/O device interface (110), storage (130), network interface (115), and memory (125). The interconnect (bus) (120) can be implemented using one or more buses. The processors (105) can be a single CPU, multiple CPUs, or a single CPU having multiple processing cores in various embodiments. In some embodiments, a processor (105) can be a digital signal processor (DSP). Memory (125) is generally included to be representative of a random-access memory (e.g., static random-access memory (SRAM), dynamic random-access memory (DRAM), or Flash). The storage (130) is generally included to be representative of a non-volatile memory, such as a hard disk drive, solid state device (SSD), removable memory cards, optical storage, or flash memory devices. In an alternative embodiment, the storage (130) can be replaced by storage area-network (SAN) devices, the cloud, or other devices connected to the processing unit (101) via the I/O device interface (110) or a communication network (150) via the network interface (115).

The network (150) can be implemented by any number of any suitable communications media (e.g., wide area network (WAN), local area network (LAN), Internet, Intranet, etc.). In certain embodiments, the network (150) can be implemented within a cloud computing environment or using one or more cloud computing services. In some embodiments, the network interface (115) communicates with both physical and virtual networks.

The processing unit (101) and the I/O Devices (112) can be local to each other, and communicate via any appropriate local communication medium (e.g., local area network (LAN), hardwire, wireless link, Intranet, etc.) or they can be physically separated and communicate over a virtual network. In some embodiments, the I/O devices (112) can include a display unit capable of presenting information (e.g., a survey or a set of questions) to a user and receiving one or more inputs (e.g., a survey response or a set of answers) from a user.

In some embodiments, the memory (125) stores a plurality of modules (126) including a data acquisition module (127) and a data processing module (128) while the storage (130) stores data sources (134) and NPS survey responses (136). However, in various embodiments, the plurality of modules (126) including a data acquisition module (127) and a data processing module (128), the data sources (134), and the NPS survey responses (136) are stored partially in memory (125) and partially in storage (130), or they are stored entirely in memory (125) or entirely in storage (130), or they are accessed over a network (150) via the network interface (115).

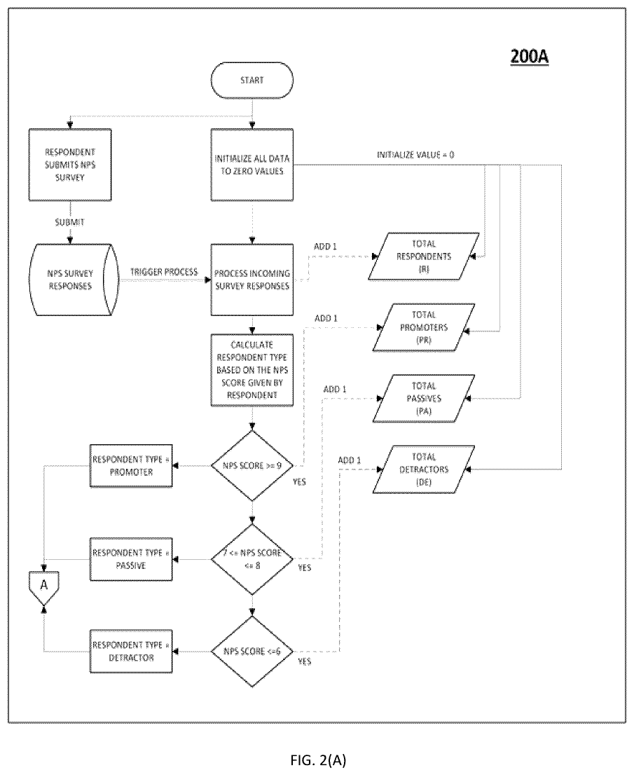

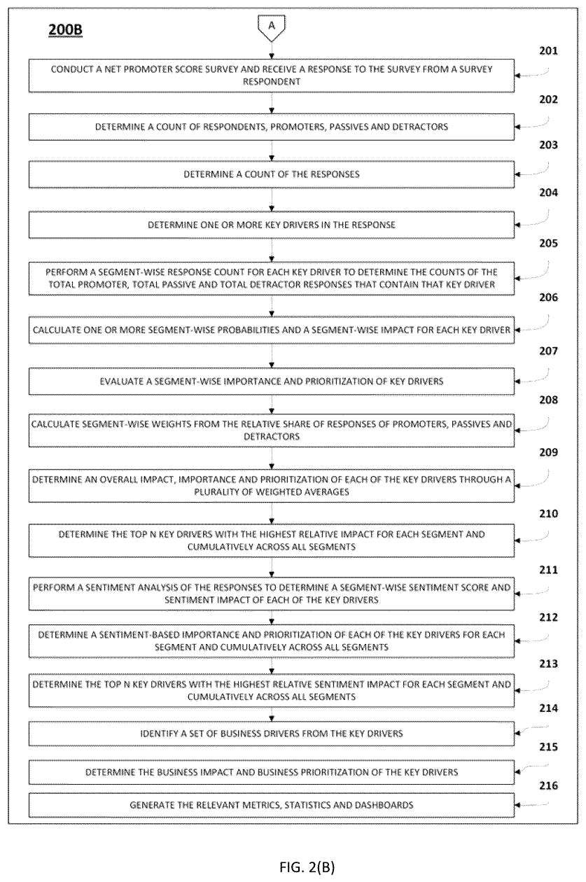

The data acquisition module (127) and data processing module (128) can store processor executable instructions for various methods such as the methods shown and described hereinafter with respect to FIG. 2(A) and FIG. 2(B) or the equivalents thereof. In some embodiments, the data sources (134) can comprise documents containing tabular data such as, but not limited to, Portable Document Format (PDF), Word, Excel, PowerPoint, Open Document Format, Google Documents, or other document files. The data sources (134) can contain media such as video files, audio files, images and animations in various file formats such as, but not limited to, MP4, MOV, MP3, WAV, JPG, PNG, GIF, etc. The data sources (134) can further contain web content such as, but not limited to, hypertext markup language (HTML) web content, extensible markup language (XML) web content, or other web content. The NPS survey responses (136) can comprise both actual responses received through the surveys, computed data fields and data indices in various embodiments. In some cases, the NPS survey responses (136) are generated by one or more processors (105) evaluating one or more data sources (134) according to data processing module (128) instructions.

The memory (125) comprises a plurality of modules (126) in the form of programmable instructions executable by the one or more hardware processors (105). The plurality of modules (126) comprise a data acquisition module (127) and a data processing module (128).

The data acquisition module (128) is configured to conduct a net promoter score survey and receive a response to a net promoter score survey from a survey respondent. The data processing module (128) is for determining one or more influencing factors of net promoter score. Further the data processing module (128) is configured to determine a count of respondents, promoters, passives and detractors, determine a count of the responses, determine one or more key drivers in each of the responses, perform segment-wise response counts for each key driver, calculate segment-wise probabilities and an impact for each key driver, evaluate a segment-wise prioritization of key drivers, determine an overall impact and importance of each of the key drivers through a plurality of weighted averages, perform a sentiment analysis to determine a sentiment score and impact of each of the key drivers, determine the sentiment-based prioritization of key drivers, identify a set of business drivers from the key drivers and determine the business prioritization for the key drivers.

FIG. 2(A) and FIG. 2(B) depicts a flow diagram of the method for determining influencing factors of net promoter score of an exemplary embodiment of a system implemented in accordance with the present disclosure.

The method for determining influencing factors of net promoter score comprising step of:
Step 201: receiving a response to a net promoter score survey from a survey respondent;
Step 202: determining a count of respondents, promoters, passives and detractors;
Step 203: determining a count of the responses;
Step 204: determining one or more key drivers in the response;
Step 205: performing a segment-wise response count for each key driver to determine the counts of the total promoter, total passive and total detractor responses containing that key driver;
Step 206: calculating one or more segment-wise probabilities and a segment-wise impact for each key driver;
Step 207: evaluating a segment-wise importance and prioritization of key drivers;
Step 208: calculating segment-wise weights from the relative share of responses of promoters, passives and detractors;
Step 209: determining an overall impact, importance and prioritization of each of the key drivers through a plurality of weighted averages (including simple average and weighted average);
Step 210: determining the top N key drivers with the highest relative impact for each segment and cumulatively across all segments;
Step 211: performing a sentiment analysis of the responses to determine a segment-wise sentiment score and sentiment impact of each of the key drivers;
Step 212: determining a sentiment-based importance and prioritization of each of the key drivers for each segment and cumulatively across all segments;
Step 213: determining the top N key drivers with the highest relative sentiment impact for each segment and cumulatively across all segments;
Step 214: identifying a set of business drivers from the key drivers;
Step 215: determining the business impact and business prioritization of the key drivers.
Step 216: generating the relevant metrics, statistics, and dashboards.

As per the standard net promoter score (NPS) methodology, based on the ratings given by the respondents in the NPS rating question, the present invention classifies the respondents into (a) “Promoters” (PR) who provide ratings of 9 or 10, (b) “Passives” (PA) who provide ratings of 7 or 8, and (c) “Detractors” (DE) who provide ratings of 6 or lower.

$$Total Promoters = PR$$

$$Total Passives = PA$$

$$Total Detractors = DE$$

$$Total Respondents RE = PR + PA + DE$$

The NPS Score is calculated as per the standard NPS Methodology.

$$Net Promoter Score = \% Promoters - \% Detractors = ( PR / RE ) - ( DE / RE ) \qquad [ Equation 1 ]$$

Further, a count of the responses is determined. Based on the responses to the second NPS question “Please tell us why?”, the data processing module (128) determines the total promoter responses (CRPR), total detractor responses (CRDE) and total passive responses (CRPA).

$$Total responses R = CRPR + CRPA + CRDE \qquad [ Equation 2 ]$$

Next, one or more key drivers or themes occurring in the responses are determined.

The data processing module (128) analyses all the responses R to determine the key drivers occurring in those responses, which is done through any of the known techniques for topic modelling, topic analysis and topic classification.

The key drivers are calculated or discovered automatically from the responses through topic modelling, topic analysis and topic classification techniques, or the key drivers are assigned manually if the responses are reviewed manually. If the original responses are in multiple languages, then the responses are translated into a common language (such as English) before doing the topic modelling/topic classification. For an illustration, assume that as a result of the topic analysis, the data processing module (128) discovers N key drivers T1 to TN in the given responses.

Further, a segment-wise response count is calculated for each key driver.

The data processing module (128) performs a segment-wise response count for each key driver, starting the process by initializing the count of responses for each key driver Tx from promoters, passives and detractors to zero.

$$Count of Promoter Response containing Key driver X , CRPR ( Tx ) = 0 \qquad [ Equation 3.1 ]$$

$$Count of Passive Response containing Key driver X , CRPA ( Tx ) = 0 \qquad [ Equation 3.2 ]$$

$$Count of Detractor Response containing Key driver X , CRDE ( Tx ) = 0 \qquad [ Equation 3.3 ]$$

Next, for each key driver Tx in the overall list of key drivers TN, the data processing module (128) tabulates the counts of the total promoter, total passive and total detractor responses that contain that key driver.

For each promoter response RPR, determine if the key driver occurs in that response. If yes, add to count CRPR(Tx).

For each passive response RPA, determine if the key driver or topic occurs in that response. If yes, add to count CRPA(Tx).

For each detractor response RDE, determine if the key driver or topic occurs in that response. If yes, add to count CRDE(Tx).

$$Total counts for key driver X , C ( Tx ) = CRPR ( Tx ) + CRPA ( Tx ) + CRDE ( Tx ) \qquad [ Equation 4 ]$$

$$Sum of total counts across all key drivers CT = \sum C ( Tx ) , \qquad [ Equation 5 ]$$

$$where$$

$$x = 1 to N$$

$$Sum of total promoter counts across all key drivers CTPR = \sum CRPR ( Tx ) , \qquad [ Equation 5.1 ]$$

$$x = 1 to N$$

$$Sum of total passive counts across all key drivers CTPA = \sum CRPA ( Tx ) , \qquad [ Equation 5.2 ]$$

$$x = 1 to N$$

$$Sum of total detractor counts across all key drivers CTDE = \sum CRDE ( Tx ) , \qquad [ Equation 5.3 ]$$

$$x = 1 to N$$

$$The probability of occurrence of key driver X ( Tx ) in each response can be calculated as \text{:} P ( C ( Tx ) ) = C ( Tx ) / CT \qquad [ Equation 6 ]$$

Further the segment-wise probabilities are calculated along with impact for each key driver.

The data processing module (128) calculates the conditional probabilities and joint probabilities for each segment of Promoters, Passives, and Detractors. Based on the probabilities, the data processing module (128) also calculates the relative impact of a segment (Promoter, Passive, Detractor) on key driver X.

For each Key driver X, the conditional probabilities and joint probabilities are calculated for each segment:

### Promoters:

$$Given key driver X , conditional probability that the key driver X occurs in the response of a promoter CP ( RPR ( Tx ) ) = P ( RPR ( Tx ) / Tx ) = CRPR ( Tx ) / C ( Tx ) \qquad [ Equation 7 ]$$

$$Joint Probability that the key driver is X and that the key driver X occurs in the response of a promoter JP ( RPR ( Tx ) ) = P ( Tx ⋂ RPR ( Tx ) ) = P ( RPR ( Tx ) / Tx ) * P ( C ( Tx ) ) \qquad [ Equation 8 ]$$

Sum of all joint probabilities JP(RPR(Tx)) across all key drivers Tx for promoters:

$$JPPR = \sum JP ( RPR ( Tx ) ) \qquad [ Equation 9 ]$$

For each key driver X, Relative Impact of a Promoter on key driver X:

$$IPR ( Tx ) = JP ( RPR ( Tx ) ) / JPPR \qquad [ Equation 10 ]$$

### Passives:

$$Given key driver X , conditional probability that the key driver X occurs in the response of a passive CP ( RPA ( Tx ) ) = P ( RPA ( Tx ) / Tx ) = CRPA ( Tx ) / C ( Tx ) \qquad [ Equation 11 ]$$

$$Joint probability that the key driver is X and that the key driver X occurs in the response of a passive JP ( RPA ( Tx ) ) = P ( Tx ⋂ RPA ( Tx ) ) = P ( RPA ( Tx ) / Tx ) * P ( C ( Tx ) ) \qquad [ Equation 12 ]$$

Sum of all joint probabilities JP(RPA(Tx)) across all key drivers Tx for passives:

$$JPPA = \sum JP ( RPA ( Tx ) ) \qquad [ Equation 13 ]$$

For each key driver X, Relative Impact of a Passive on key driver X:

$$IPA ( Tx ) = JP ( RPA ( Tx ) ) / JPPA \qquad [ Equation 14 ]$$

### Detractors:

$$Given key driver X , conditional probability that the key driver X occurs in the response of a detractor CP ( RDE ( Tx ) ) = P ( RDE ( Tx ) / Tx ) = CRDE ( Tx ) / C ( Tx ) \qquad [ Equation 15 ]$$

$$Joint probability that the key driver X and that the key driver X occurs in the response of a detractor JP ( RDE ( Tx ) ) = P ( Tx ⋂ RDE ( Tx ) ) = P ( RDE ( Tx ) / Tx ) * P ( C ( Tx ) ) \qquad [ Equation 16 ]$$

Sum of all joint probabilities JP(RDE(Tx)) across all key drivers Tx for detractors:

$$JPDE = \sum JP ( RDE ( Tx ) ) \qquad [ Equation 17 ]$$

For each key driver X, Relative Impact of a Detractor on key driver X:

$$IDE ( Tx ) = JP ( RDE ( Tx ) ) / JPDE \qquad [ Equation 18 ]$$

Further the segment-wise importance and prioritization of key drivers is determined. Based on the impact of the various segments (Promoters, Passives, Detractors) on each key driver X as per Equation 10, Equation 14 and Equation 18 given above, their relative importance for each segment can be determined. Based on the Impact calculations, the data processing module (128) determines the Top 3 (or Top N) key drivers with the highest relative impact for each segment, which can be used to determine the importance and prioritization of each key driver for promoters, passives and detractors.

Next, the data processing module (128) determines an overall impact and importance of the key drivers through a plurality of weighted averages.

The data processing module (128) calculates the overall impact of a key driver X through simple averages using the following equation 19, where the values of IPR(Tx), IPA(Tx) and IDE(Tx) have been calculated in Equation 10, Equation 14 and Equation 18 above.

$$Overall Impact of a Key Driver I ( Tx ) = ( IPR ( Tx ) + IPA ( Tx ) + IDE ( Tx ) ) / 3 \qquad [ Equation 19 ]$$

The data processing module (128) also calculates the overall importance of a key driver X by applying weighted averages.

Weights are determined for each segment from the relative share of responses of the Promoters, Passives and Detractors.

$$Weight of Promoters , WPR = CTPR / CT \qquad [ Equation 20 ]$$

$$Weight of Passives , WPA = CTPA / CT \qquad [ Equation 21 ]$$

$$Weight of Detractors , WDE = CTDE / CT \qquad [ Equation 22 ]$$

$$Overall Weighted Impact of a Key driver WI ( Tx ) = ( WPR * IPR ( Tx ) + WPA * IPA ( Tx ) + WDE * IDE ( Tx ) ) \qquad [ Equation 23 ]$$

Based on the Overall Impact calculations, the data processing module (128) determines the importance and prioritization of each key driver for all the segments (promoters, passives, and detractors) combined. Based on this, the data processing module (128) determines the Top 3 (or Top N) key drivers with the highest relative impact across all segments.

The method further includes the step of performing a sentiment analysis of the responses to determine the segment-wise importance and prioritization of key drivers. This step is utilized (a) as a standalone approach or (b) in addition to the preceding steps wherein the present invention used the segment-wise response counts and probabilities to determine the importance and priority of key drivers. For the sentiment analysis, 7 sentiments are used and weights are assigned to them as given below in Table 1.

TABLE 1
Sentiments and their weights

| | Sentiment Weight | Sentiment Weight |
|---|---|---|
| Sentiment (S) | (SW) | Variable |
| Clearly Positive | 3 | SWCP |
| Positive | 2 | SWP |
| Mixed | 1 | SWM |
| Neutral | 0 | SWNU |
| Unknown | 0 | SWU |
| Negative | −2 | SWN |
| Clearly Negative | −3 | SWCN |

Now for each segment promoters, passives and detractors, the data processing module (128) performs sentiment analysis for each response and calculates the distribution of the responses as per their sentiment, for each key driver and segment (promoters, passives and detractors).

For each sentiment S, sentiment weight SW and key driver Tx, the segment-wise response counts are initialized as follows:

$$Count of Promoter Response containing Sentiment S and Key driver X , CSRPR ( Tx ) = 0 \qquad [ Equation 24 ]$$

$$Count of Passive Response containing Sentiment S and Key driver X , CSRPA ( Tx ) = 0 \qquad [ Equation 25 ]$$

$$Count of Detractor Response containing Sentiment S and Key driver X , CSRDE ( Tx ) = 0 \qquad [ Equation 26 ]$$

For each key driver Tx, the data processing module (128) defines the sentiment counts as follows, where the notation RPR denotes Promoter Responses, RPA denotes Passive Responses and RDE denotes Detractor Responses:

$$Clearly Positive Sentiment Count CSCP ( Tx ) = CSCPRPR ( Tx ) + CSCPRPA ( Tx ) + CSCPRDE ( Tx ) \qquad [ Equation 27 ]$$

$$Positive Sentiment Count CSP ( Tx ) = CSPRPR ( Tx ) + CSPRPA ( Tx ) + CSPRDE ( Tx ) \qquad [ Equation 28 ]$$

$$Mixed Sentiment Count CSM ( Tx ) = CSMRPR ( Tx ) + CSMRPA ( Tx ) + CSMRDE ( Tx ) \qquad [ Equation 29 ]$$

$$Neutral Sentiment Count CSNU ( Tx ) = CSNURPR ( Tx ) + CSNURPA ( Tx ) + CSNURDE ( Tx ) \qquad [ Equation 30 ]$$

$$Unknown Sentiment Count CSU ( Tx ) = CSURPR ( Tx ) + CSURPA ( Tx ) + CSURDE ( Tx ) \qquad [ Equation 31 ]$$

$$Negative Sentiment Count CSN ( Tx ) = CSNRPR ( Tx ) + CSNRPA ( Tx ) + CSNRDE ( Tx ) \qquad [ Equation 32 ]$$

$$Clearly Negative Sentiment Count CSCN ( Tx ) = CSCNRPR ( Tx ) + CSCNRPA ( Tx ) + CSCNRDE ( Tx ) \qquad [ Equation 33 ]$$

The response count for each sentiment S of each segment for each key driver Tx is determined:

$$Promoter Response Count for key driver X , CRPR ( Tx ) = CSCPRPR ( Tx ) + CSPRPR ( Tx ) + CSMRPR ( Tx ) + CSNURPR ( Tx ) + CSURPR ( Tx ) + CSNRPR ( Tx ) + CSCNRPR ( Tx ) \qquad [ Equation 34 ]$$

$$Passive Response Count for key driver X , CRPA ( Tx ) = CSCPRPA ( Tx ) + CSPRPA ( Tx ) + CSMRPA ( Tx ) + CSNURPA ( Tx ) + CSURPA ( Tx ) + CSNRPA ( Tx ) + CSCNRPA ( Tx ) \qquad [ Equation 35 ]$$

$$Detractor Response Count for key driver X , CRDE ( Tx ) = CSCPRDE ( Tx ) + CSPRDE ( Tx ) + CSMRDE ( Tx ) + CSNURDE ( Tx ) + CSURDE ( Tx ) + CSNRDE ( Tx ) + CSCNRDE ( Tx ) \qquad [ Equation 36 ]$$

Further the sentiment score and sentiment impact for each key driver Tx for each segment is determined.

The sentiment score SS for each key driver Tx is calculated by multiplying the sentiment counts with the corresponding sentiment weights:

$$Sentiment Score SS ( Tx ) = CSCP ( Tx ) * SWCP + CSP ( Tx ) * SWP + CSM ( Tx ) * SWM + CSNU ( Tx ) * SWNU + CSU ( Tx ) * SWU + CSN ( Tx ) * SWN + CSCN ( Tx ) * SWCN \qquad [ Equation 37 ]$$

The total sentiment score is the sum of all the key driver-wise sentiment scores.

$$Total Sentiment Score SS = \sum SS ( Tx ) \qquad [ Equation 38 ]$$

The sentiment impact SSI for each key driver Tx is calculated by dividing the sentiment score for the key driver SS(Tx) by the total sentiment score SS.

$$Sentiment Impact for a Key driver Tx , SSI ( Tx ) = SS ( Tx ) / SS \qquad [ Equation 39 ]$$

The total sentiment impact SSI is the sum of all key driver-wise sentiment impacts. The total sentiment impact SSI should be 1.0 or 100%.

$$Total Sentiment Impact SSI = \sum SSI ( Tx ) should be 100 \% or 1. \qquad [ Equation 40 ]$$

For each segment promoters, passives and detractors, the key driver-wise sentiment scores and sentiment impacts are calculated.

### Promoters:

$$Promoter Sentiment Score for Key Driver X , SSPR ( Tx ) = CSCPRPR ( Tx ) * SWCP + CSPRPR ( Tx ) * SWP + CSMRPR ( Tx ) * SWM + CSNURPR ( Tx ) * SWNU + CSURPR ( Tx ) * SWU + CSNRPR ( Tx ) * SWN + CSCNRPR ( Tx ) * SWCN \qquad [ Equation 41 ]$$

$$Total Promoter Sentiment Score SSPR = \sum SSPR ( Tx ) \qquad [ Equation 42 ]$$

$$Promoter Sentiment Impact for a Key Driver Tx , \\ SSIPR ( Tx ) = SSPR ( Tx ) / SSPR \qquad [ Equation 43 ]$$

### Passives:

$$Passive Sentiment Score for Key Driver X , SSPA ( Tx ) = CSCPRPA ( Tx ) * SWCP + CSPRPA ( Tx ) * SWP + CSMRPA ( Tx ) * SWM + CSNURPA ( Tx ) * SWNU + CSURPA ( Tx ) * SWU + CSNRPA ( Tx ) * SWN + CSCNRPA ( Tx ) * SWCN \qquad [ Equation 44 ]$$

$$Total Passive Sentiment Score SSPA = \sum SSPA ( Tx ) \qquad [ Equation 45 ]$$

$$Passive Sentiment Impact for a Key Driver Tx , \\ SSIPA ( Tx ) = SSPA ( Tx ) / SSPA \qquad [ Equation 46 ]$$

### Detractors:

$$Detractor Sentiment Score for Key Driver X , SSDE ( Tx ) = CSCPRDE ( Tx ) * SWCP + CSPRDE ( Tx ) * SWP + CSMRDE ( Tx ) * SWM + CSNURDE ( Tx ) * SWNU + CSURDE ( Tx ) * SWU + CSNRDE ( Tx ) * SWN + CSCNRDE ( Tx ) * SWCN \qquad [ Equation 47 ]$$

$$Total Detractor Sentiment Score SSDE = \sum SSDE ( Tx ) \qquad [ Equation 48 ]$$

$$Detractor Sentiment Impact for a Key Driver Tx , \\ SSIDE ( Tx ) = SSDE ( Tx ) / SSDE \qquad [ Equation 49 ]$$

Next, based on the sentiment score and sentiment impact for each key driver, the priority and importance of each key driver is calculated, which is done for each segment (promoters, passives and detractors) or at a consolidated level (by aggregating the sentiment scores and sentiment impacts across segments). The lower the sentiment score/sentiment impact, the higher should be the prioritization for the key driver Tx, since respondents expressing negative sentiments have a higher likelihood of spreading negative opinions or becoming detractors, and so the underlying key driver should be addressed on higher priority. The method further includes the step of identifying a set of business drivers from the key drivers.

As an illustration, assume the business (organization or company) has a budget B to run different initiatives INx in a defined time period. Assume that for each key driver Tx identified in the key driver analysis, it will cost a budget Bx to run the set of initiatives INx for key driver X.

$$Total Budget B = \sum Bx , where x = 1 to N \qquad [ Equation 50 ]$$

Now, how should a business prioritize a set of initiatives so that the given budget B can be most efficiently distributed to run initiatives which will have maximum impact on customer satisfaction and improve the NPS scores in the best possible way within the given budget?

Prioritization is based on the importance of a key driver and the cost or budget required to implement the initiatives for that key driver.

$$Business Impact of a Key Driver ( Tx ) , \\ BPI ( Tx ) = WI ( Tx ) ( or I ( Tx ) ) * Bx \qquad [ Equation 51 ]$$

In Equation 51, WI(Tx) is the Overall Weighted Impact of a key driver from Equation 23, and I(Tx) is the Overall Impact of a key driver from Equation 19.

Thus, the business can focus on the most important key drivers based on business impact to determine the business priority for the key drivers, and then use this prioritization to drive the set of initiatives for each of the prioritized key drivers within the given budget. Thus, the key drivers determined through net promoter score are used to determine the business drivers that improve the overall net promoter score for the business.

As an exemplary illustration for the method outlined by the present invention, assume that in an NPS survey, a total of 100 respondents responded to the survey, and based on the NPS rating given by each respondent, the count of promoters, passives and detractors is determined as follows:
Total Respondents, RE=100
Total Promoters (NPS Rating 9 or 10), PR=30
Total Passives (NPS Rating 7 or 8), PA=40
Total Detractors (NPS Rating 0 thru 6), DE=30

### Net Promoter Score

The Net Promoter Score (NPS) for the survey can be calculated as per Equation 1.

$$Net Promoter Score ( NPS ) = \% Promoters - \% Detractors = 30 - 30 = 0$$

$$NPS = 0$$

### Response Counts

Assume that each respondent submitted a text response/qualitative response to the survey. The total responses can be calculated as per Equation 2.

$$Total Responses , R = 100$$

$$Total Promoter Responses , RPR = 30$$

$$Total Passive Responses , RPA = 40$$

$$Total Detractor Responses , RDE = 30$$

$$Total Responses , R = RPR + RPA + RDE = 100$$

### Key Drivers/Topics and Response Counts

Assume that all the responses (R=100) are analyzed to determine the key topics/key drivers. Assume that 10 key drivers, T1 thru T10, are identified through the analysis of the 100 responses.

Key driver Tx=T1 thru T10, where X=1 thru 10

Next, the data processing module (128) initializes the count of responses to zero for each key driver from each segment (promoters, passives and detractors) as per Equation 3.

Count of Promoter Response containing key driver X, CRPR(Tx)=0

Count of Passive Response containing key driver X, CRPA(Tx)=0

Count of Detractor Response containing key driver X, CRDE(Tx)=0

Next, for each key driver or topic Tx, the data processing module (128) tabulates the counts of the total promoter, total passive and total detractor responses that contain that key driver or topic.

Total counts for each Key Driver X, C(Tx) are calculated as per Equation 4, the sum of total counts across all key drivers CT is calculated as per Equation 5 and the probability of occurrence P (C(Tx)) of key driver X(Tx) in a given response is calculated as per Equation 6.

Assume that for the 10 key drivers T1 thru T10 identified in the example, the response count distribution and probability of occurrence of a given key driver Tx is as follows in Table 2.

TABLE 2
Response count distribution and probability of occurrence of a
given key driver Tx

| | | | | | Probability |
|---|---|---|---|---|---|
| | | | | Total | Occurrence |
| | Promoter | Passive | Detractor | Count | of Key |
| Key | Response | Response | Response | for Key | driver X, |
| driver | Count | Count | Count | driver | P(C(Tx)) |
| Tx | CRPR(Tx) | CRPA(Tx) | CRDE(Tx) | X:C(Tx) | [=C(Tx)/CT] |
| T1 | 2 | 5 | 3 | 10 | 0.013 |
| T2 | 20 | 50 | 30 | 100 | 0.130 |
| T3 | 3 | 5 | 2 | 10 | 0.013 |
| T4 | 10 | 70 | 20 | 100 | 0.130 |
| T5 | 70 | 20 | 10 | 100 | 0.130 |
| T6 | 20 | 10 | 70 | 100 | 0.130 |
| T7 | 30 | 30 | 40 | 100 | 0.130 |
| T8 | 50 | 10 | 40 | 100 | 0.130 |
| T9 | 20 | 10 | 20 | 50 | 0.064 |
| T10 | 10 | 10 | 80 | 100 | 0.130 |
| | CRPR = | CRPA = | CRDE = | CT = | P(CT) = |
| | 235 | 220 | 315 | 770 | 1.0 |

### Segment-Wise Probabilities and Impact for Each Key Driver X

Next, the data processing module (128) calculates the conditional probabilities and joint probabilities for each segment of Promoters, Passives, and Detractors.

Based on the probabilities, the data processing module (128) also calculates the relative impact of a segment (Promoter, Passive, Detractor) on key driver X.

For Promoters, the conditional probability CP (RPR(Tx)) is calculated as per Equation 7, the joint probability JP(RPR(Tx)) is calculated as per Equation 8 and the sum of all joint probabilities for promoters JPPR is calculated as per Equation 9.

For each key driver X, the Relative Impact of a Promoter on key driver X, IPR(Tx) is calculated as per Equation 10. For the illustrative example, the calculations for Promoters are indicated in Table 3 below.

TABLE 3
Probabilities and Impact for each Key Driver X for Promoters

| | | | | | Joint | |
|---|---|---|---|---|---|---|
| | | | | Conditional | Probability of | |
| | | | | Probability of | Key driver X | Impact of |
| | | | Probability of | Promoter | and Promoter | Promoters |
| | Promoter | Total | Occurrence of | Response | Response | on Key driver |
| Key | Response | Counts for | Key driver X, | containing | containing | Tx, IPR(Tx) = |
| driver | Count | Key driver X: | P(C(Tx)) | Key driver X: | Key driver X: | JP(RPR(Tx))/ |
| Tx | CRPR(Tx) | C(Tx) | [=C(Tx)/CT] | CP(RPR(Tx)) | JP(RPR(Tx)) | JPPR |
| T1 | 2 | 10 | 0.013 | 0.2 | 0.0026 | 0.9% |
| T2 | 20 | 100 | 0.130 | 0.2 | 0.0260 | 8.5% |
| T3 | 3 | 10 | 0.013 | 0.3 | 0.0039 | 1.3% |
| T4 | 10 | 100 | 0.130 | 0.1 | 0.0130 | 4.3% |
| T5 | 70 | 100 | 0.130 | 0.7 | 0.0909 | 29.8% |
| T6 | 20 | 100 | 0.130 | 0.2 | 0.0260 | 8.5% |
| T7 | 30 | 100 | 0.130 | 0.3 | 0.0390 | 12.8% |
| T8 | 50 | 100 | 0.130 | 0.5 | 0.0649 | 21.3% |
| T9 | 20 | 50 | 0.064 | 0.4 | 0.0260 | 8.5% |
| T10 | 10 | 100 | 0.130 | 0.1 | 0.0130 | 4.3% |
| | CRPR = | CT = | P(CT) = | | JPPR = | 100% |
| | 235 | 770 | 1.0 | | 0.3052 | |

For Passives, the conditional probability CP (RPA(Tx)) is calculated as per Equation 11, the joint probability JP(RPA(Tx)) is calculated as per Equation 12 and the sum of all joint probabilities for passives JPPA is calculated as per Equation 13.

For each key driver X, the Relative Impact of a Passive on key driver X, IPA(Tx) is calculated as per Equation 14. For the illustrative example, the calculations for Passives are indicated in Table 4 below.

TABLE 4
Probabilities and Impact for each Key Driver X for Passives

| | | | | | Joint | |
|---|---|---|---|---|---|---|
| | | | | Conditional | Probability of | |
| | | | | Probability | Key driver X | Impact of |
| | | | Probability of | of Passive | and Passive | Passives on |
| | Passive | Total | Occurrence of | Response | Response | Key driver |
| Key | Response | Counts for | Key driver X, | containing | containing | Tx, IPA(Tx) = |
| driver | Count | Key driver X: | P(C(Tx)) | Key driver X: | Key driver X: | JP(RPA(Tx))/ |
| Tx | CRPA(Tx) | C(Tx) | [=C(Tx)/CT] | CP(RPA(Tx)) | JP(RPA(Tx)) | JPPA |
| T1 | 5 | 10 | 0.013 | 0.5 | 0.0065 | 2.3% |
| T2 | 50 | 100 | 0.130 | 0.5 | 0.0649 | 22.7% |
| T3 | 5 | 10 | 0.013 | 0.5 | 0.0065 | 2.3% |
| T4 | 70 | 100 | 0.130 | 0.7 | 0.0909 | 31.8% |
| T5 | 20 | 100 | 0.130 | 0.2 | 0.0260 | 9.1% |
| T6 | 10 | 100 | 0.130 | 0.1 | 0.0130 | 4.5% |
| T7 | 30 | 100 | 0.130 | 0.3 | 0.0390 | 13.6% |
| T8 | 10 | 100 | 0.130 | 0.1 | 0.0130 | 4.5% |
| T9 | 10 | 50 | 0.064 | 0.2 | 0.0130 | 4.5% |
| T10 | 10 | 100 | 0.130 | 0.1 | 0.0130 | 4.5% |
| | CRPA = | CT = | P(CT) = | | JPPA = | 100% |
| | 220 | 770 | 1.0 | | 0.2857 | |

For Detractors, the conditional probability CP (RDE(Tx)) is calculated as per Equation 15, the joint probability JP(RDE(Tx)) is calculated as per Equation 16 and the sum of all joint probabilities for detractors JPDE is calculated as per Equation 17.

For each key driver X, the Relative Impact of a Detractor on key driver X, IDE(Tx) is calculated as per Equation 18. For the illustrative example, the calculations for Detractors are indicated in Table 5 below.

TABLE 5
Probabilities and Impact for each Key Driver X for Detractors

| | | | | | Joint | |
|---|---|---|---|---|---|---|
| | | | | Conditional | Probability of | |
| | | | | Probability of | Key driver X | Impact of |
| | | | Probability of | Detractor | and Detractor | Detractors |
| | Detractor | Total | Occurrence of | Response | Response | on Key driver |
| Key | Response | Counts for | Key driver X, | containing | containing | Tx, IDE(Tx) = |
| driver | Count | Key driver X: | P(C(Tx)) | Key driver X: | Key driver X: | JP(RDE(Tx))/ |
| Tx | CRDE(Tx) | C(Tx) | [=C(Tx)/CT] | CP(RDE(Tx)) | JP(RDE(Tx)) | JPDE |
| T1 | 3 | 10 | 0.013 | 0.3 | 0.0039 | 1.0% |
| T2 | 30 | 100 | 0.130 | 0.3 | 0.0390 | 9.5% |
| T3 | 2 | 10 | 0.013 | 0.2 | 0.0026 | 0.6% |
| T4 | 20 | 100 | 0.130 | 0.2 | 0.0260 | 6.3% |
| T5 | 10 | 100 | 0.130 | 0.1 | 0.0130 | 3.2% |
| T6 | 70 | 100 | 0.130 | 0.7 | 0.0909 | 22.2% |
| T7 | 40 | 100 | 0.130 | 0.4 | 0.0519 | 12.7% |
| T8 | 40 | 100 | 0.130 | 0.4 | 0.0519 | 12.7% |
| T9 | 20 | 50 | 0.064 | 0.4 | 0.0260 | 6.3% |
| T10 | 80 | 100 | 0.130 | 0.8 | 0.1039 | 25.4% |
| | CRDE = | CT = | P(CT) = | | JPDE = | 100% |
| | 315 | 770 | 1.0 | | 0.4091 | |

### Segment-Wise Importance and Prioritization of Key Drivers

The impact of the various segments (Promoters, Passives, and Detractors) on each key driver is calculated as illustrated in Tables 3, 4 and 5 above. Based on this, the relative importance and prioritization for each segment is determined as illustrated in Table 6 below, which outlines the top 3 key drivers for each segment (Promoters, Passives and Detractors).

TABLE 6
Segment-wise Importance and Prioritization of Key drivers

| | Impact of | | Impact of | | Impact of | |
|---|---|---|---|---|---|---|
| | Promoters | | Passives on | | Detractors | |
| | on Key driver | | Key driver | | on Key driver | |
| Key | Tx, IPR(Tx) = | Top 3 Key | Tx, IPA(Tx) = | Top 3 Key | Tx, IDE(Tx) = | Top 3 Key |
| driver | JP(RPR(Tx))/ | drivers for | JP(RPA(Tx))/ | drivers for | JP(RDE(Tx))/ | drivers for |
| Tx | JPPR | Promoters | JPPA | Passives | JPDE | Detractors |
| T1 | 0.9% | | 2.3% | | 1.0% | |
| T2 | 8.5% | | 22.7% | 2 | 9.5% | |
| T3 | 1.3% | | 2.3% | | 0.6% | |
| T4 | 4.3% | | 31.8% | 1 | 6.3% | |
| T5 | 29.8% | 1 | 9.1% | | 3.2% | |
| T6 | 8.5% | | 4.5% | | 22.2% | 2 |
| T7 | 12.8% | 3 | 13.6% | 3 | 12.7% | 3 |
| T8 | 21.3% | 2 | 4.5% | | 12.7% | 3 |
| T9 | 8.5% | | 4.5% | | 6.3% | |
| T10 | 4.3% | | 4.5% | | 25.4% | 1 |
| | 100% | | 100% | | 100% | |

Table 6 determines the segment-wise importance and prioritization of key drivers:

For Promoters, 3 key drivers T5, T8 and T7 are the most important.

For Passives, 3 key drivers T4, T2 and T7 are the most important.

For Detractors, 4 key drivers T10, T6, T7 and T8 are the most important.

Next, Table 7 illustrates the calculation of the overall impact I(Tx) of each of the key drivers Tx using simple averages as per Equation 19.

TABLE 7
Overall Importance and Prioritization of Key drivers based
on Simple Averages

| | | | | Overall | |
|---|---|---|---|---|---|
| | Impact of | Impact of | Impact of | Impact, | |
| | Promoters | Passives | Detractors | I(Tx) = | Top 5 |
| Key | on Key | on Key | on Key | (IPR(Tx) + | Overall |
| driver | driver Tx, | driver Tx, | driver Tx, | IPA(Tx) + | Key |
| Tx | IPR(Tx) | IPA(Tx) | IDE(Tx) | IDE(Tx))/3 | drivers |
| T1 | 0.9% | 2.3% | 1.0% | 1.4% | |
| T2 | 8.5% | 22.7% | 9.5% | 13.6% | 3 |
| T3 | 1.3% | 2.3% | 0.6% | 1.4% | |
| T4 | 4.3% | 31.8% | 6.3% | 14.1% | 1 |
| T5 | 29.8% | 9.1% | 3.2% | 14.0% | 2 |
| T6 | 8.5% | 4.5% | 22.2% | 11.8% | |
| T7 | 12.8% | 13.6% | 12.7% | 13.0% | 4 |
| T8 | 21.3% | 4.5% | 12.7% | 12.8% | 5 |
| T9 | 8.5% | 4.5% | 6.3% | 6.5% | |
| T10 | 4.3% | 4.5% | 25.4% | 11.4% | |
| | 100% | 100% | 100% | 100% | |

Table 7 determines the Overall Importance and Prioritization of Key drivers based on the overall impact of a key driver calculated through simple averages. As per the calculations in the illustrative example, the key drivers T4, T5, T2, T7 and T8 are the top 5 overall key drivers.

Next, the overall impact WI(Tx) of each of the key drivers Tx is calculated using weighted averages.

The weights are derived for each segment from the share of responses of the Promoters, Passives and Detractors as per equations 20, 21 and 22.

Weight of Promoter WPR=CRPR/CT=235/770=30.52%

Weight of Passive WPA=CRPA/CT=220/770=28.57%

Weight of Detractor WDE=CRDE/CT=315/770=40.91%

The Overall Weighted Impact of a Key driver WI(Tx) is calculated as per Equation 23, and illustrated in Table 8 below.

TABLE 8
Overall Importance and Prioritization of Key drivers based on
Weighted Averages

| | Weighted | | | | |
|---|---|---|---|---|---|
| | Impact of | Weighted | Impact of | Overall | |
| | Promoters | Impact of | Detractors | Weighted | |
| | on Key | Passives on | on Key | Impact, | |
| | driver Tx, | Key driver | driver Tx, | WI(Tx) = | Top 5 |
| Key | WIPR = | Tx, WIPA = | WIDE = | (WIPR + | Overall |
| driver | WPR * | WPA * | WDE * | WIPA + | Key |
| Tx | IPR(Tx) | IPA(Tx) | IDE(Tx) | WIDE) | drivers |
| T1 | 0.26% | 0.65% | 0.39% | 1.3% | |
| T2 | 2.60% | 6.49% | 3.90% | 13.0% | 1 |
| T3 | 0.39% | 0.65% | 0.26% | 1.3% | |
| T4 | 1.30% | 9.09% | 2.60% | 13.0% | 1 |
| T5 | 9.09% | 2.60% | 1.30% | 13.0% | 1 |
| T6 | 2.60% | 1.30% | 9.09% | 13.0% | 1 |
| T7 | 3.90% | 3.90% | 5.19% | 13.0% | 1 |
| T8 | 6.49% | 1.30% | 5.19% | 13.0% | 1 |
| T9 | 2.60% | 1.30% | 2.60% | 6.5% | |
| T10 | 1.30% | 1.30% | 10.39% | 13.0% | 1 |
| | 30.52% | 28.57% | 40.91% | 100% | |

Table 8 determines the overall importance and prioritization of key drivers, based on the overall impact of a key driver calculated through weighted averages. As per the calculations in the illustrative example, the key drivers T2, T4, T5, T6, T7, T8 and T10 are the top 7 overall key drivers, each with an equal impact of 13% each.

As seen from the above examples in Tables 7 and 8, the overall importance of key drivers and their prioritization is different based on whether simple averages or weighted averages are used.

Next, the segment-wise importance and priority of key drivers using sentiment analysis of the responses is calculated.

Assume that for the sentiment analysis, the sentiments S, sentiment weights SW and sentiment weight variables from Table 1 are used.

For each segment promoters, passives and detractors, the data processing module (128) takes the key driver-wise response counts from Table 2 and performs the sentiment analysis of the responses. From the sentiment analysis, assume that the distribution of the responses as per their sentiment is determined for each segment as given in Tables 10, 11 and 12 below, and the response counts are calculated as per Equation 24 through Equation 36.

Table 10 illustrates the response count distribution, sentiment score and sentiment impact for each key driver Tx for promoters.

Promoter Sentiment Score for Key Driver X, SSPR(Tx) is calculated as per Equation 41, Total Promoter Sentiment Score SSPR is calculated as per Equation 42 and Promoter Sentiment Impact for a Key Driver Tx, SSIPR(Tx) is calculated as per Equation 43.

TABLE 10
Response count distribution and Sentiment Impact for Promoters

| | Sentiment Weight | | | | | |
|---|---|---|---|---|---|---|
| | | 3 | | | | |
| | | Clearly | 2 | 1 | 0 | 0 |
| | Promoter | Positive | Positive | Mixed | Neutral | Unknown |
| | Response | Sentiment | Sentiment | Sentiment | Sentiment | Sentiment |
| Key | Count | Count | Count | Count | Count | Count |
| Driver | CRPR | CSCPRPR | CSPRPR | CSMRPR | CSNURPR | CSURPR |
| Tx | (Tx) | (Tx) | (Tx) | (Tx) | (Tx) | (Tx) |
| T1 | 2 | 1 | 0 | 0 | 1 | 0 |
| T2 | 20 | 4 | 4 | 2 | 4 | 0 |
| T3 | 3 | 0 | 1 | 1 | 1 | 0 |
| T4 | 10 | 2 | 2 | 2 | 2 | 0 |
| T5 | 70 | 10 | 10 | 10 | 15 | 5 |
| T6 | 20 | 3 | 3 | 4 | 2 | 0 |
| T7 | 30 | 5 | 5 | 5 | 5 | 0 |
| T8 | 50 | 5 | 10 | 10 | 10 | 0 |
| T9 | 20 | 2 | 2 | 3 | 3 | 0 |
| T10 | 10 | 1 | 1 | 2 | 2 | 0 |
| | CRPR = | CSCPRPR = | CSPRPR = | CSMRPR = | CSNURPR = | CSURPR = |
| | 235 | 33 | 38 | 39 | 45 | 5 |

| | Sentiment Weight | | | | |
|---|---|---|---|---|---|
| | | −3 | | | |
| | −2 | Clearly | | | |
| | Negative | Negative | | | |
| | Sentiment | Sentiment | Sentiment | Sentiment | |
| Key | Count | Count | Score | Impact | |
| Driver | CSNRPR | CSCNRPR | SSPR | SSIPR | Top 5 |
| Tx | (Tx) | (Tx) | (Tx) | (Tx) | Priority |
| T1 | 0 | 0 | 3 | 10.34% | 4 |
| T2 | 3 | 3 | 7 | 24.14% | |
| T3 | 0 | 0 | 3 | 10.34% | 4 |
| T4 | 1 | 1 | 7 | 24.14% | |
| T5 | 10 | 10 | 10 | 34.48% | |
| T6 | 4 | 4 | −1 | −3.45% | 3 |
| T7 | 5 | 5 | 5 | 17.24% | |
| T8 | 10 | 5 | 10 | 34.48% | |
| T9 | 5 | 5 | −12 | −41.38% | 1 |
| T10 | 2 | 2 | −1 | −10.34% | 2 |
| | CRNRPR = | CSCNRPR = | SSPR = | SSIPR = | |
| | 40 | 35 | 29 | 1.0 | |
| | | | | (100%) | |

Table 11 illustrates the response count distribution, sentiment score and sentiment impact for each key driver Tx for passives.

Passive Sentiment Score for Key Driver X, SSPA(Tx) is calculated as per Equation 44, Total Passive Sentiment Score SSPA is calculated as per Equation 45 and Passive Sentiment Impact for a Key Driver Tx, SSIPA(Tx) is calculated as per Equation 46.

TABLE 11
Response count distribution and Sentiment Impact for Passives

| | Sentiment Weight | | | | |
|---|---|---|---|---|---|
| | | 3 | | | |
| | | Clearly | 2 | 1 | 0 |
| | Passive | Positive | Positive | Mixed | Neutral |
| | Response | Sentiment | Sentiment | Sentiment | Sentiment |
| Key | Count | Count | Count | Count | Count |
| Driver | CRPA | CSCPRPA | CSPRPA | CSMRPA | CSNURPA |
| Tx | (Tx) | (Tx) | (Tx) | (Tx) | (Tx) |
| T1 | 5 | 1 | 1 | 0 | 1 |
| T2 | 50 | 5 | 10 | 10 | 10 |
| T3 | 5 | 1 | 1 | 1 | 1 |
| T4 | 70 | 10 | 10 | 10 | 15 |
| T5 | 20 | 3 | 3 | 4 | 2 |
| T6 | 10 | 2 | 3 | 1 | 2 |
| T7 | 30 | 5 | 5 | 5 | 5 |
| T8 | 10 | 3 | 3 | 2 | 2 |
| T9 | 10 | 2 | 2 | 1 | 1 |
| T10 | 10 | 1 | 1 | 2 | 2 |
| | CRPA = | CSCPRPA = | CSPRPA = | CSMRPA = | CSNURPA = |
| | 220 | 33 | 39 | 36 | 41 |

| | Sentiment Weight | | | | | |
|---|---|---|---|---|---|---|
| | | | −3 | | | |
| | 0 | −2 | Clearly | | | |
| | Unknown | Negative | Negative | | | |
| | Sentiment | Sentiment | Sentiment | Sentiment | Sentiment | |
| Key | Count | Count | Count | Score | Impact | |
| Driver | CSURPA | CSNRPA | CSCNRPA | SSPA | SSIPA | Top 5 |
| Tx | (Tx) | (Tx) | (Tx) | (Tx) | (Tx) | Priority |
| T1 | 0 | 1 | 1 | 0 | 0.00% | 3 |
| T2 | 0 | 10 | 5 | 10 | 19.61% | |
| T3 | 0 | 1 | 0 | 4 | 7.84% | 5 |
| T4 | 5 | 10 | 10 | 10 | 19.61% | |
| T5 | 0 | 4 | 4 | −1 | −1.96% | 2 |
| T6 | 0 | 1 | 1 | 8 | 15.69% | |
| T7 | 0 | 5 | 5 | 5 | 9.80% | |
| T8 | 0 | 0 | 0 | 17 | 33.33% | |
| T9 | 0 | 2 | 2 | 1 | 1.96% | 4 |
| T10 | 0 | 2 | 2 | −3 | −5.88% | 1 |
| | CSURPA = | CRNRPA = | CSCNRPA = | SSPA = | SSIPA = | |
| | 5 | 36 | 30 | 51 | 1.0 | |
| | | | | | (100%) | |

Table 12 illustrates the response count distribution, sentiment score and sentiment impact for each key driver Tx for detractors.

Detractor Sentiment Score for Key Driver X, SSDE(Tx) is calculated as per Equation 47, Total Detractor Sentiment Score SSDE is calculated as per Equation 48 and Detractor Sentiment Impact for a Key Driver Tx, SSIDE(Tx) is calculated as per Equation 49.

TABLE 12
Response count distribution and Sentiment Impact for Detractors

| | | Sentiment Weight | | | |
|---|---|---|---|---|---|
| | | 3 | | | |
| | | Clearly | 2 | 1 | 0 |
| | Detractor | Positive | Positive | Mixed | Neutral |
| | Response | Sentiment | Sentiment | Sentiment | Sentiment |
| Key | Count | Count | Count | Count | Count |
| Driver | CRDE | CSCPRDE | CSPRDE | CSMRDE | CSNURDE |
| Tx | (Tx) | (Tx) | (Tx) | (Tx) | (Tx) |
| T1 | 3 | 0 | 0 | 0 | 1 |
| T2 | 30 | 0 | 1 | 1 | 3 |
| T3 | 2 | 0 | 0 | 1 | 1 |
| T4 | 20 | 0 | 1 | 2 | 2 |
| T5 | 10 | 0 | 1 | 2 | 2 |
| T6 | 70 | 5 | 5 | 5 | 5 |
| T7 | 40 | 0 | 0 | 0 | 0 |
| T8 | 40 | 5 | 5 | 5 | 5 |
| T9 | 20 | 2 | 2 | 3 | 3 |
| T10 | 80 | 0 | 5 | 10 | 5 |
| | CRDE = | CSCPRDE = | CSPRDE = | CSMRDE = | CSNURDE = |
| | 315 | 12 | 20 | 29 | 27 |

| | Sentiment Weight | | | | | |
|---|---|---|---|---|---|---|
| | | | −3 | | | |
| | 0 | −2 | Clearly | | | |
| | Unknown | Negative | Negative | | | |
| | Sentiment | Sentiment | Sentiment | Sentiment | Sentiment | |
| Key | Count | Count | Count | Score | Impact | |
| Driver | CSURDE | CSNRDE | CSCNRDE | SSDE | SSIDE | Top 5 |
| Tx | (Tx) | (Tx) | (Tx) | (Tx) | (Tx) | Priority |
| T1 | 0 | 1 | 1 | −5 | 1.11% | |
| T2 | 0 | 10 | 15 | −62 | 13.72% | 4 |
| T3 | 0 | 0 | 0 | 1 | −0.22% | |
| T4 | 0 | 10 | 5 | −31 | 6.86% | 5 |
| T5 | 0 | 3 | 2 | −8 | 1.77% | |
| T6 | 0 | 25 | 25 | −95 | 21.02% | 2 |
| T7 | 0 | 30 | 10 | −90 | 19.91% | 3 |
| T8 | 0 | 10 | 10 | −20 | 4.42% | |
| T9 | 0 | 5 | 5 | −12 | −2.65% | |
| T10 | 3 | 30 | 30 | −130 | 28.76% | 1 |
| | CSURDE = | CRNRDE = | CSCNRDE = | SSDE = | SSIDE = | |
| | 0 | 124 | 103 | −452 | 1.0 | |
| | | | | | (100%) | |

Based on the Sentiment Score and Sentiment Impact for each key driver Tx, the data processing module (128) calculates the priority of key drivers for each segment. The lower the score or impact, the higher is the prioritization for the key driver Tx, since respondents expressing negative sentiments have a higher likelihood of spreading negative opinions or becoming detractors. The top 5 priority key drivers for promoters, passives and detractors are illustrated in Tables 10, 11 and 12 above.

Next, the data processing module (128) identifies the business drivers from the key drivers.

Assume the business (organization or company) has a total budget B to run different initiatives INx in a defined time period. Assume that for each key driver Tx identified in the key driver analysis, the budget is Bx to run the set of initiatives INx for key driver X.

Total Budget B=ΣBx, where x=1 to N (from Equation 50).

Let the total budget B be USD $100, for this example.

Let the key driver-wise budgets Bx (or costs) be as illustrated in Table 13 below. Overall Impact I(Tx) for each key driver based on simple averages is taken from Table 7 above.

The business impact BPI(Tx) of each of the key drivers Tx is calculated from Equation 51 and illustrated in Table 13 below.

TABLE 13
Identifying Key drivers based on Budgets and Business Impact

| | | Prioritization | | | |
|---|---|---|---|---|---|
| | | of Key | | | |
| | | Drivers | Budget Bx | Business | Business |
| Key | Overall | (Based on | (USD) for | Impact | Prioritization |
| driver | Impact | Overall | each Key | BPI(Tx) = | of Key |
| Tx | I(Tx) | Impact) | driver Tx | I(Tx) * Bx | Drivers |
| T1 | 1.4% | 9 | $5 | 7 | 9 |
| T2 | 13.6% | 3 | $5 | 68 | 5 |
| T3 | 1.4% | 9 | $5 | 7 | 9 |
| T4 | 14.1% | 1 | $10 | 141 | 3 |
| T5 | 14.0% | 2 | $20 | 280 | 2 |
| T6 | 11.8% | 6 | $10 | 118 | 4 |
| T7 | 13.0% | 4 | $5 | 65 | 6 |
| T8 | 12.8% | 5 | $5 | 64 | 7 |
| T9 | 6.5% | 8 | $5 | 32.5 | 8 |
| T10 | 11.4% | 7 | $30 | 342 | 1 |
| | 100% | | USD 100 | | |

From the above Table 13, for a total budget of USD $100, the top 3 key drivers in terms of business impact and business prioritization are T10, T5 and T4, whereas in terms of prioritization based on overall impact the top 3 key drivers are T4, T5 and T2. Thus the present invention makes it possible to differentiate between business prioritization and general impact-based prioritization of key drivers determined from a net promoter score survey.

In another illustration, if the business had a budget of USD 30, based on the data and calculations from Table 13 the business may choose to prioritize initiatives related to any one of the following combinations of key drivers:

Key drivers T5 and T4, which are the top 2 key drivers in terms of prioritization based on overall impact and ranked 2 and 3 in terms of business prioritization, for an overall impact of 28.1% and a cost of USD 30.

Key drivers T4, T6, T2 and T7 (business priorities 3, 4, 5 and 6) for an overall impact of 52.5% and a cost of USD 30. In this case, Key driver T5, which has second rank, has not been considered.

Key driver T10, for a cost of USD 30, for an impact of 11.4%. In terms of overall impact, this is a less optimal outcome than the other 2 choices, but there may be business reasons to focus on T10 because this key driver has the highest importance for Detractors (from Table 8 or Table 12).

The present invention also provides a non-transitory computer-readable storage medium for determining influencing factors of net promoter score. The storage medium comprising an executable code which when executed by one or more units of a system causes a processor to receive a response to a net promoter score survey from a survey respondent and determining a count of respondents, promoters, passives and detractors. The processor is further configured to determine a count of the responses and determine one or more key drivers in the response. The processor is further configured to perform a segment-wise response count for each key driver to determine the counts of the total promoter, total passive and total detractor responses containing that key driver and calculate one or more segment-wise probabilities and a segment-wise impact for each key driver. The processor is configured to evaluate a segment-wise importance and prioritization of key drivers and calculate segment-wise weights from the relative share of responses of promoters, passives and detractors. The processor is configured to determine an overall impact, importance and prioritization of each of the key drivers through a plurality of weighted averages (including simple average and weighted average) and determine the top key drivers with the highest relative impact for each segment and cumulatively across all segments. The processor is further configured to perform a sentiment analysis of the responses to determine a segment-wise sentiment score and sentiment impact of each of the key drivers and determine a sentiment-based importance and prioritization of each of the key drivers for each segment and cumulatively across all segments. The processor is further configured to determine the top N key drivers with the highest relative sentiment impact for each segment and cumulatively across all segments and identify a set of business drivers from the key drivers. The processor is further configured to determine the business impact and business prioritization of the key drivers and generate the relevant metrics, statistics, and dashboards.

The present invention also provides a user device for determining influencing factors of net promoter score. The user device comprise of a memory and a processor connected with the memory. The processor is configured to receive a response to a net promoter score survey from a survey respondent and determining a count of respondents, promoters, passives and detractors. The processor is further configured to determine a count of the responses and determine one or more key drivers in the response. The processor is further configured to perform a segment-wise response count for each key driver to determine the counts of the total promoter, total passive and total detractor responses containing that key driver and calculate one or more segment-wise probabilities and a segment-wise impact for each key driver. The processor is configured to evaluate a segment-wise importance and prioritization of key drivers and calculate segment-wise weights from the relative share of responses of promoters, passives and detractors. The processor is configured to determine an overall impact, importance and prioritization of each of the key drivers through a plurality of weighted averages (including simple average and weighted average) and determine the top key drivers with the highest relative impact for each segment and cumulatively across all segments. The processor is further configured to perform a sentiment analysis of the responses to determine a segment-wise sentiment score and sentiment impact of each of the key drivers and determine a sentiment-based importance and prioritization of each of the key drivers for each segment and cumulatively across all segments. The processor is further configured to determine the top N key drivers with the highest relative sentiment impact for each segment and cumulatively across all segments and identify a set of business drivers from the key drivers. The processor is further configured to determine the business impact and business prioritization of the key drivers and generate the relevant metrics, statistics, and dashboards.

Thus, the present invention enables the business to choose the key drivers that the business wants to address to improve the net promoter score (and hence customer satisfaction). The choice of key drivers determines the initiatives that the business takes up, and the business drivers that these initiatives impact to improve the overall net promoter score.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include modules that perform certain tasks. The modules discussed herein may include script, batch, or other executable files. The modules may be stored on a machine-readable or computer readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removable or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a module for calling sub-modules may be decomposed so that each sub-module performs its function and passes control directly to another sub-module.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described.

1. A system (100) for determining influencing factors of net promoter score, comprising of:
one or more hardware processors (105); and
a memory (125) coupled to the one or more hardware processor (105) and the memory (125) comprises a plurality of modules (126) in the form of programmable instructions executable by the one or more hardware processors (105);
wherein:
the plurality of modules (126) comprise of a data acquisition module (127) for receiving a response to a net promoter score survey from a survey respondent, a data processing module (128) for determining one or more influencing factors of net promoter score and a display module;
said data processing module (128) is configured to:
a) determine a count of respondents, promoters, passives and detractors;
b) determine a count of the responses;
c) determine one or more key drivers in each of the responses;
d) perform segment-wise response counts for each key driver;
e) calculate one or more segment-wise probabilities and an impact for each key driver;
f) evaluate a segment-wise prioritization of key drivers;
g) determine an overall impact and importance of each of the key drivers through a plurality of weighted averages;
h) perform a sentiment analysis to determine a sentiment score and impact of each of the key drivers;
i) determine the sentiment-based prioritization of key drivers;
j) identify a set of business drivers from the key drivers and determine the business prioritization for the key drivers; and
said display module is configured to display a set of key drivers and business drivers to a user of the system (100).

2. The system (100) for determining influencing factors of net promoter score as claimed in claim 1, wherein the data acquisition module (127) includes scanner, camera, keyboard, microphone, mouse and touchpad.

3. The system (100) for determining influencing factors of net promoter score as claimed in claim 1, wherein the data processing module (128) refers to a processing unit (101) and is preferably a microprocessor.

4. The system (100) for determining influencing factors of net promoter score as claimed in claim 1, wherein the data acquisition module (127) transfers the response from the respondent to the data processing module (128).

5. The system (100) for determining influencing factors of net promoter score as claimed in claim 1, wherein the system (100) further comprise of an input means (112) for receiving an input data and a storage unit (130) for storing incoming input data or having a pre-stored data.

6. The system (100) for determining influencing factors of net promoter score as claimed in claim 1, wherein the key drivers are calculated or discovered automatically from the responses through one or more topic modelling, topic analysis and topic classification techniques, or the key drivers are assigned manually if the responses are reviewed manually.

7. The system (100) for determining influencing factors of net promoter score as claimed in claim 1, wherein the key drivers determine the business initiatives that the business takes up, and the business drivers that these initiatives impact to improve the overall net promoter score.

8. The system (100) for determining influencing factors of net promoter score as claimed in claim 1, wherein the display module includes but not limited to a computer monitor, LCD screen, LED screen, TV or flat screen or curved screen, mobile phone or tablet screen, smart watch screen, wearable devices such as virtual reality headsets, virtual displays, embedded displays, augmented reality displays, mixed reality displays, etc.

9. A method for determining influencing factors of net promoter score comprising steps of:
a) receiving a response to a net promoter score survey from a survey respondent;
b) determining a count of respondents, promoters, passives and detractors;
c) determining a count of the responses;
d) determining one or more key drivers in the response;
e) performing a segment-wise response count for each key driver to determine the counts of the total promoter, total passive and total detractor responses containing that key driver;
f) calculating one or more segment-wise probabilities and a segment-wise impact for each key driver;
g) evaluating a segment-wise importance and prioritization of key drivers;
h) calculating segment-wise weights from the relative share of responses of promoters, passives and detractors;
i) determining an overall impact, importance and prioritization of each of the key drivers through a plurality of weighted averages (including simple average and weighted average);
j) determining the top key drivers with the highest relative impact for each segment and cumulatively across all segments;
k) performing a sentiment analysis of the responses to determine a segment-wise sentiment score and sentiment impact of each of the key drivers;
l) determining a sentiment-based importance and prioritization of each of the key drivers for each segment and cumulatively across all segments;
m) determining the top N key drivers with the highest relative sentiment impact for each segment and cumulatively across all segments;
n) identifying a set of business drivers from the key drivers;
o) determining the business impact and business prioritization of the key drivers; and
p) generating the relevant metrics, statistics, and dashboards.

10. The method for determining influencing factors of net promoter score as claimed in claim 9,
wherein said net promoter score survey includes a set of questions for the respondent.

11. The method for determining influencing factors of net promoter score as claimed in claim 9, wherein said key drivers are calculated or discovered automatically from the responses through one or more topic modelling, topic analysis and topic classification techniques, or the key drivers are assigned manually if the responses are reviewed manually.

12. The method for determining influencing factors of net promoter score as claimed in claim 9, wherein said segment-wise importance and prioritization of key drivers is done by calculating one or more conditional probabilities and joint probabilities.

13. The method for determining influencing factors of net promoter score as claimed in claim 9, wherein said method includes a step of relative impact calculation based on the conditional probabilities and joint probabilities.

14. The method for determining influencing factors of net promoter score as claimed in claim 9, wherein calculating the relative impact for each key driver for each of the segments of promoters, passives and detractors assists in determining the top key drivers for each segment and across all segments.

15. A non-transitory computer-readable storage medium for determining influencing factors of net promoter score, wherein the storage medium comprising an executable code which when executed by one or more units of a system causes a processor to:
a) receive a response to a net promoter score survey from a survey respondent;
b) determine a count of respondents, promoters, passives and detractors;
c) determine a count of the responses;
d) determine one or more key drivers in the response;
e) perform a segment-wise response count for each key driver to determine the counts of the total promoter, total passive and total detractor responses containing that key driver;
f) calculate one or more segment-wise probabilities and a segment-wise impact for each key driver;
g) evaluate a segment-wise importance and prioritization of key drivers;
h) calculate segment-wise weights from the relative share of responses of promoters, passives and detractors;
i) determine an overall impact, importance and prioritization of each of the key drivers through a plurality of weighted averages (including simple average and weighted average);
j) determine the top key drivers with the highest relative impact for each segment and cumulatively across all segments;
k) perform a sentiment analysis of the responses to determine a segment-wise sentiment score and sentiment impact of each of the key drivers;
l) determine a sentiment-based importance and prioritization of each of the key drivers for each segment and cumulatively across all segments;
m) determine the top N key drivers with the highest relative sentiment impact for each segment and cumulatively across all segments;
n) identify a set of business drivers from the key drivers;
o) determine the business impact and business prioritization of the key drivers; and
p) generate the relevant metrics, statistics, and dashboards.

16. A user device for determining influencing factors of net promoter score, comprises:
a memory; and
a processor connected with the memory, wherein the processor is configured to:
a) receive a response to a net promoter score survey from a survey respondent;
b) determine a count of respondents, promoters, passives and detractors;
c) determine a count of the responses;
d) determine one or more key drivers in the response;
e) perform a segment-wise response count for each key driver to determine the counts of the total promoter, total passive and total detractor responses containing that key driver;
f) calculate one or more segment-wise probabilities and a segment-wise impact for each key driver;
g) evaluate a segment-wise importance and prioritization of key drivers;
h) calculate segment-wise weights from the relative share of responses of promoters, passives and detractors;
i) determine an overall impact, importance and prioritization of each of the key drivers through a plurality of weighted averages (including simple average and weighted average);
j) determine the top key drivers with the highest relative impact for each segment and cumulatively across all segments;
k) perform a sentiment analysis of the responses to determine a segment-wise sentiment score and sentiment impact of each of the key drivers;
l) determine a sentiment-based importance and prioritization of each of the key drivers for each segment and cumulatively across all segments;
m) determine the top N key drivers with the highest relative sentiment impact for each segment and cumulatively across all segments;
n) identify a set of business drivers from the key drivers;
o) determine the business impact and business prioritization of the key drivers; and
p) generate the relevant metrics, statistics, and dashboards.
